(19) United States
(12) Patent Application Publication
(10) Pub. No.: US 2011/0170169 A1
(43) Pub. Date: Jul. 14, 2011

(54) ELECTROPHORETIC DISPLAY DEVICE AND ELECTRONIC APPARATUS

(75) Inventors: Yuko Komatsu, Suwa-shi (JP); Takashi Sato, Chino-shi (JP)

(73) Assignee: Seiko Epson Corporation, Tokyo (JP)

(21) Appl. No.: 12/973,157

(22) Filed: Dec. 20, 2010

(30) Foreign Application Priority Data
Jan. 13, 2010 (JP) 2010-005006

(51) Int. Cl. G02F 1/167

(52) U.S. Cl. 359/296

(57) ABSTRACT

An electrophoretic display device including: a first substrate; a second substrate that is disposed so as to face the first substrate; an electrophoretic device that is disposed between the first substrate and the second substrate; a plurality of first electrodes that are formed so as to overlie the electrophoretic device side of the first substrate; and a second electrode that is formed on the electrophoretic device side of the second substrate so as to face the plurality of the first electrodes. The second electrode has light reflectivity.

### CROSS-REFERENCE TO RELATED APPLICATION

This application is based on and claims priority from Japanese Patent Application No. 2010-005006, filed on Jan. 13, 2010, the contents of which are incorporated herein by reference.

### BACKGROUND

1. Technical Field

The present invention relates to an electrophoretic display device and an electronic apparatus.

2. Related Art

In an electrophoretic display device, a counter substrate has a configuration in which a transparent electrode (opposite electrode) is evenly formed so as to underlie a transparent substrate, and a device substrate has a configuration in which pixel electrodes and thin film devices (transistors) that drive the pixel electrodes are formed so as to overlie the device substrate, and an electrophoretic device is disposed between the counter substrate and the device substrate. A desired potential difference is generated between the transparent electrode and the pixel electrodes to form an image. In a device having such a configuration, an image is generally viewed from the transparent electrode side that is formed on the counter substrate (for example, JP-A-2003-107535).

Unfortunately, an electric field diffuses from the pixel electrodes to the opposite electrode with the result that the image viewed from a viewing plane exhibits a blur gradation boundary, and therefore the outline of the image may be expanded or may become narrow. Furthermore, in the case where a color filter is provided on the opposite electrode side, misalignment occurs between a color boundary of the color filter and either of a color boundary of the electrophoretic device or the outline of the image, thereby causing moire or the like.

Another configuration is also known, in which a transparent semiconductor such as an oxide semiconductor is used to enable an image on an electrophoretic display device to be viewed from a device substrate side. However, in amorphous silicon thin film transistors (TFTs) and polysilicon TFTs that have been widely utilized as TFT devices, interconnections that are used for a thin film device and a circuit do not have transparency, and therefore a disadvantage arises in that an image cannot be sufficiently recognized in the case where the image is viewed from the back side of the device substrate. Even in the case where transparent devices such as oxide semiconductor devices are used, usage of metallic materials for interconnections similarly causes the above disadvantage. In addition, the transparent semiconductor is not capable of exhibiting a transmittance of 100%, and therefore a disadvantage such as decreased image contrast has been caused.

### SUMMARY

An advantage of some aspects of the invention is that it provides an electrophoretic display device and electronic apparatus that exhibit excellent visibility as a result of environmental light being sufficiently utilized in the case where an image is viewed from a device substrate side.

According to an aspect of the invention, there is provided an electrophoretic display device including: a first substrate; a second substrate that is disposed so as to face the first substrate; an electrophoretic device that is disposed between the first substrate and the second substrate; a plurality of first electrodes that are formed so as to overlie the electrophoretic device side of the first substrate; and a second electrode that is formed on the electrophoretic device side of the second substrate so as to face the plurality of the first electrodes. The second electrode has light reflectivity.

By virtue of this advantageous configuration, because the second electrode has light reflectivity, incident light from the first substrate side passes through the electrophoretic device, is then reflected by the second electrode, then passes through the electrophoretic device again, and is then emitted from the first substrate. Therefore, a display section of a reflective electrophoretic display device is capable of exhibiting improved brightness. Accordingly, an image can be displayed with high quality, and the image is excellently recognized from the first substrate side.

Furthermore, it is preferable that a color filter is formed between the first substrate and the electrophoretic device.

By virtue of this advantageous configuration, because the color filter is provided between the first substrate and the electrophoretic device, the color filter is positioned near the first electrode. Therefore, an image viewed from the first substrate side does not exhibit a blur gradation boundary, and a misalignment is prevented from being generated between a color boundary of the color filter and either of a color boundary of the electrophoretic device or the outline of the image, thereby being able to preclude generation of moire or the like. Accordingly, an image is displayed with improved contrast, and visibility is enhanced.

Furthermore, it is preferable that the second substrate has electrical conductivity and functions as the second electrode.

By virtue of this advantageous configuration, the second substrate functions as the second electrode, and therefore pattern formation of the second electrode is excluded, leading to easy production.

Furthermore, it is preferable that the electrophoretic display device has a plurality of scanning lines and a storage capacitor having a pair of electrodes, the scanning lines being individually connected to at least one of the first electrodes through a selection transistor, and the storage capacitor being connected to a corresponding one of the first electrodes. A corresponding one of the scanning lines functions as one of the pair of electrodes.

By virtue of this advantageous configuration, the electrophoretic display device has the storage capacitor having a Cs-on-gate structure in which a corresponding one of the scanning lines function as one of the pair of the electrodes, and therefore each pixel is capable of having a high aperture ratio.

Furthermore, it is preferable that the electrophoretic device has a plurality of microcapsules in which a plurality of electrophoretic particles are encapsulated and that the plurality of the microcapsules are fixed by a binder between the first substrate and the second substrate, the binder having light reflectivity.

By virtue of this advantageous configuration, the binder fixes the microcapsules between the first substrate and the second substrate and has light reflectivity, and therefore light that does not reach the second electrode can be efficiently reflected. Namely, light beams that have passed through the microcapsules and have then entered the second electrode are reflected by the second electrode, and the other light beams are reflected by the binder. Accordingly, environmental light can be sufficiently utilized, and the brightness of the display section is improved, and more excellent visibility is capable of being provided.

Furthermore, it is preferable that a partition having light reflectivity is formed between the first substrate and the second substrate and that the partition, electrophoretic particles, and a dispersion medium form the electrophoretic device, the electrophoretic particles and dispersion medium being enclosed in a space defined by the partition.

By virtue of this advantageous configuration, the partition having light reflectivity is provided on the electrophoretic device side of the second substrate, and the partition functions with the result that incident light from the first substrate side is reflected not only by the second electrode but by the partition. Therefore, the brightness of each pixel is improved, and more excellent visibility can be provided.

According to another aspect of the invention, there is provided an electronic apparatus including the electrophoretic display device having the above advantageous configurations.

By virtue of this advantageous configuration, the electronic apparatus can be provided, which includes the electrophoretic display device that enables an image to be displayed with high quality.

### BRIEF DESCRIPTION OF THE DRAWINGS

The invention will be described with reference to the accompanying drawings, wherein like numbers reference like elements.

FIG. 1 illustrates the general configuration of an electrophoretic display device according to a fist embodiment.

FIG. 2 is a circuit block diagram illustrating the electrophoretic display device according to the fist embodiment.

FIG. 3 illustrates pixel circuits of the electrophoretic display device according to the fist embodiment.

FIG. 4A is a cross-sectional view partially illustrating a display section of the electrophoretic display device.

FIG. 4B is a cross-sectional view schematically illustrating a microcapsule.

FIG. 5A is a plan view illustrating the pixels formed on a device substrate.

FIG. 5B is a cross-sectional view illustrating one of the pixels taken along a line VIB-VIB in FIG. 5A.

FIG. 6A illustrates operation of an electrophoretic device.

FIG. 6B illustrates operation of the electrophoretic device.

FIG. 7 is a cross-sectional view illustrating an electrophoretic display device according to a second embodiment.

FIG. 8 is a cross-sectional view illustrating an electrophoretic display device according to a third embodiment in an enlarged manner.

FIG. 9 illustrates an example of an electronic apparatus.

FIG. 10 illustrates another example of the electronic apparatus.

FIG. 11 illustrates another example of the electronic apparatus.

### DESCRIPTION OF EXEMPLARY EMBODIMENTS

Embodiments of the invention will be hereinafter described with reference to the accompanying drawings. In each of the drawings used for the description, the sizes of components have been appropriately changed to allow the components to be visibly recognized.

### First Embodiment

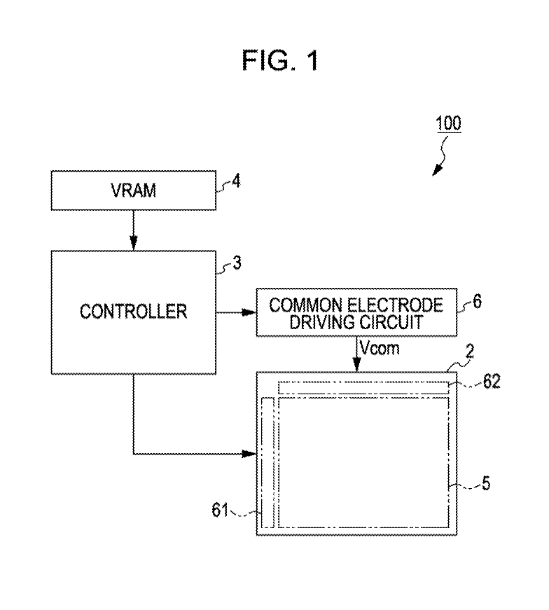

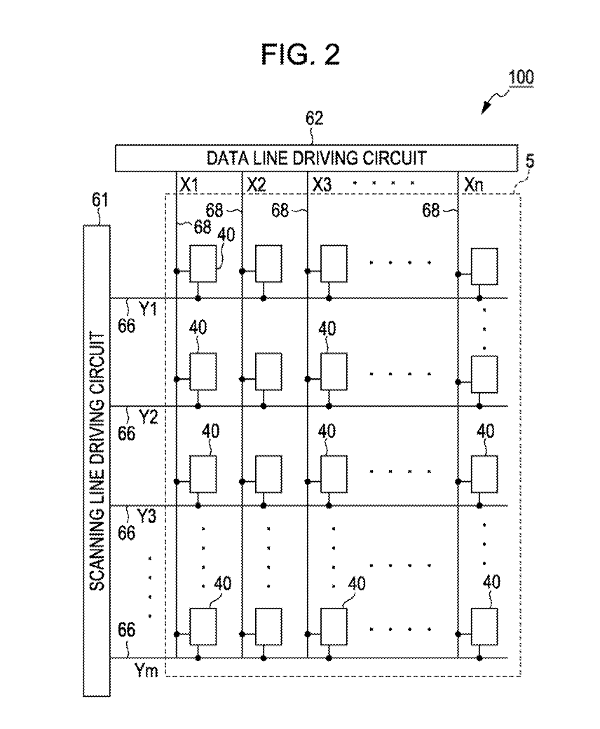

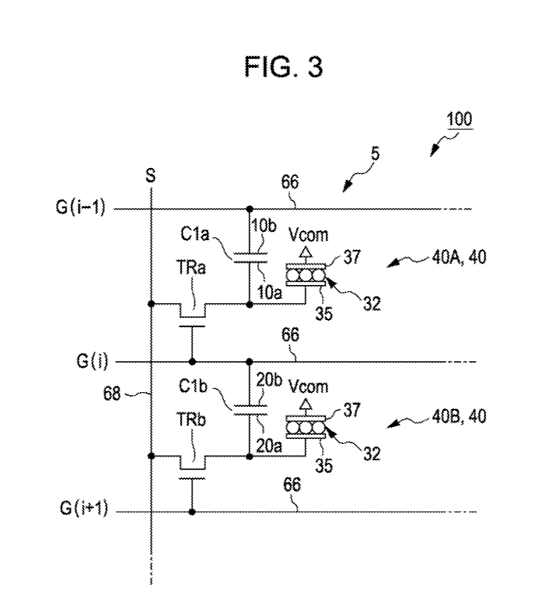

FIG. 1 illustrates the general configuration of an electrophoretic display device according to an embodiment of the invention. FIG. 2 is a circuit diagram illustrating a display according to the embodiment. FIG. 3 illustrates pixel circuits of the electrophoretic display device.

With reference to FIG. 1, an electrophoretic display device 100 has a display 2, a controller 3, a video random access memory (VRAM) 4, and a common electrode-driving circuit 6.

The display 2 receives control signals output from the controller 3 and receives a voltage supplied from the common electrode-driving circuit 6, thereby forming an image. The display 2 has a display section 5, a scanning line-driving circuit 61, and a data line-driving circuit 62.

The controller 3 functions as a control section of the electrophoretic display device 100. The controller 3 receives image data to be displayed as an image from the VRAM 4 and then controls the display 2 to display the image. More specifically, the controller 3 controls the scanning line-driving circuit 61 and data line-driving circuit 62 of the display 2 and controls the common electrode-driving circuit 6 to display an image. Examples of the control signals to be output from the controller 3 include a clock signal, a timing signal such as a start pulse, image data, and a source voltage.

The VRAM 4 is used to temporarily store image data of one or more images to be subsequently displayed on the display section 5 among image data stored in a memory section (not illustrated) such as a flash memory.

The common electrode-driving circuit 6 is connected to a common electrode 37 (opposite electrode, see FIG. 3) provided in the display 2 and supplies an appropriate common electrode-voltage potential Vcom to the common electrode 37.

FIG. 2 is a circuit diagram illustrating the general configuration of the electrophoretic display device 100 according to the embodiment.

The electrophoretic display device 100 has the display section 5 in which a plurality of pixels 40 are arranged. The scanning line-driving circuit 61 and the data line-driving circuit 62 are disposed in the vicinity of the display section 5. Each of the scanning line-driving circuit 61 and the data line-driving circuit 62 is connected to the controller 3.

A plurality of scanning lines 66 extend from the scanning line-driving circuit 61 across the display section 5, and a plurality of data lines 68 extend from the data line-driving circuit 62 across the display section 5. The pixels 40 are formed so as to correspond to portions at which the scanning lines 66 intersect the data lines 68.

The scanning line-driving circuit 61 is connected to the individual pixels 40 through the m scanning lines 66 (Y1, Y2, Y3, . . . , Ym) that extend in a row direction. On the basis of the control performed by the controller 3, the scanning line-driving circuit 61 sequentially selects the appropriate scanning lines 66 from the first column to a mth column and then outputs selection signals to the pixels 40 through the selected scanning lines 66, the selection signals defining on-timings of selection transistors (selection transistors TRa and TRb, see FIG. 3) provided in the pixels 40. The pixels 40 are arranged in the manner of a matrix so as to be parallel to the Y axis in the m numbers and so as to be parallel to the X axis in the n numbers.

In the electrophoreteic display device 100 of the embodiment, the numbers of the scanning lines 66 and data lines 68 to be provided can be appropriately determined within natural numbers.

The data line-driving circuit 62 is connected to the individual pixels 40 through the n data lines 68 (X1, X2, X3, . . . , Xn) that extend in a column direction. On the basis of the control performed by the controller 3, the data line-driving circuit 62 outputs image signals to the pixels 40, the image signals defining one-bit image data corresponding to each of the image pixels 40.

In the embodiment, in the case where image data (pixel data) “0” (white) is defined, image signals at a low level (L) are output to the pixels 40, and in the case where image data (pixel data) “1” (black) is defined, image signals at a high level (H) are output to the pixels 40. Furthermore, in the case where image data of intermediate gradation is defined, image signals at an intermediate level between L and H are output to the pixels 40.

FIG. 3 illustrates the circuit configurations of the pixels 40A and 40B.

The pixels 40A and 40B of the display section 5 have the selection transistors TRa and TRb as pixel-switching devices, pixel electrodes 35 (first electrodes), electrophoretic devices 32, a common electrode 37 (second electrode), and storage capacitors C1a and C1b, respectively.

Each of the selection transistors TRa and TRb has the structure of a negative metal oxide semiconductor (N-MOS) TFT.

The individual electrophoretic devices 32 are disposed between the pixel electrodes 35 and the common electrode 37.

The storage capacitors C1a and C1b are formed so as to overlie a device substrate 30 (first substrate) that will be hereinafter described. A pair of electrodes 10a and 10b are disposed so as to face each other with a dielectric film interposed therebetween, thereby forming the storage capacitor C1a, and a pair of electrodes 20a and 20b are disposed so as to face each other with a dielectric film interposed therebetween, thereby forming the storage capacitor C1b. The storage capacitors C1a and C1b are respectively charged by image signal voltages written through the selection transistors TRa and TRb. Although details will be hereinafter described, the storage capacitors C1a and C1b of the embodiment employ Cs-on-gate structures, in which the storage capacitors C1a and C1b are configured by utilizing individually adjacent different scanning lines 66.

In the selection transistor TRa of the pixel 40A, the gate electrode is connected to the scanning line 66 of an ith row, the source electrode is connected to the data line 68, and the drain electrode is connected to the electrode 10a of the storage capacitor C1a and is connected to the pixel electrode 35. The electrode 10b of the storage capacitor C1a is connected to the scanning line 66 of an i−1th row.

The storage capacitor C1a of the pixel 40A forms a capacitance by utilizing the pixel electrode 35 of the pixel 40A and the scanning line 66 of the preceding i−1th row.

In the selection transistor TRb of the pixel 40B, the gate electrode is connected to the scanning line 66 of an i+1th row, the source electrode is connected to the data line 68, and the drain electrode is connected to the electrode 20a of the storage capacitor C1b and is connected to the pixel electrode 35. The electrode 20b of the storage capacitor C1b is connected to the scanning line 66 of the ith row.

The storage capacitor C1b of the pixel 40B forms a capacitance by utilizing the pixel electrode 35 of the pixel 40B and the scanning line 66 of the preceding ith row.

In the pixel circuit, for example, in the case where the scanning line 66 of the ith row is selected, the selection transistor TRa enters an on-state, and then image signals are input from the data line 68 into the pixel electrode 35 through the selection transistor TRa, and the storage capacitor C1a is charged. In the case where the scanning line 66 of the ith row is not selected, the selection transistor TRa enters an off-state, while charged particles of the electrophoretic device 32 of the pixel 40A are still moved by utilizing energy stored in the storage capacitor C1a.

In the case where the scanning line 66 of the i+1th row is selected, the selection transistor TRb enters an on-state, and then image signals are input from the data line 68 into the pixel electrode 35 through the selection transistor TRb, and the storage capacitor C1b is charged. In the case where the scanning line 66 of the i+1th row is not selected, the selection transistor TRb enters an off-state, while charged particles of the electrophoretic device 32 of the pixel 40B are still moved by utilizing energy stored in the storage capacitor C1b.

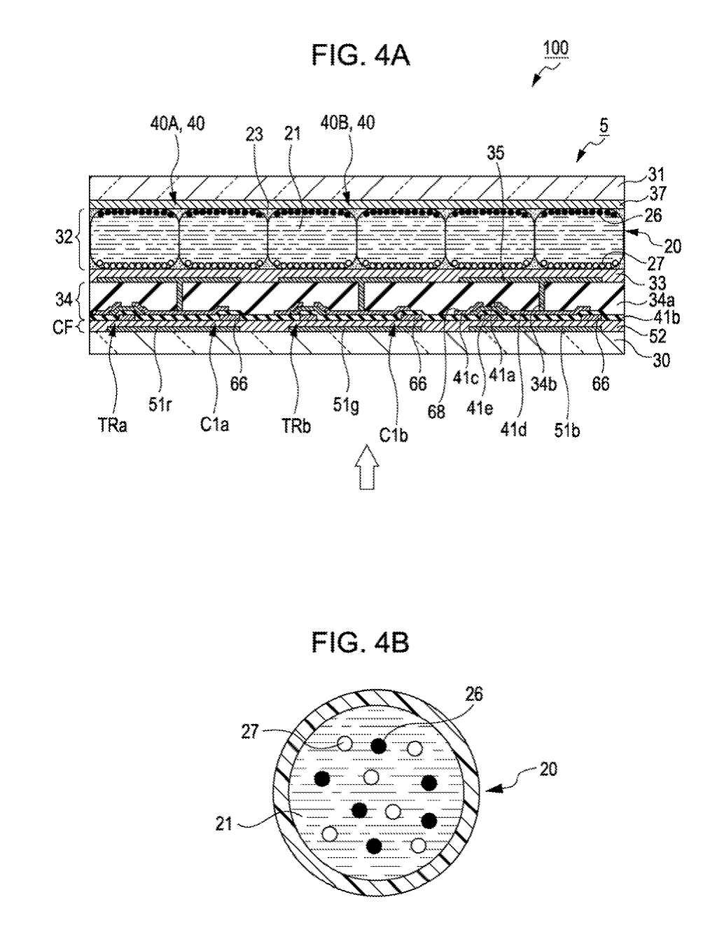

FIG. 4A is a cross-sectional view partially illustrating the display section 5 of the electrophoretic display device 100.

The electrophoretic display device 100 has a configuration in which the electrophoretic device 32 is disposed between the device substrate 30 and a counter substrate 31 (second substrate), the electrophoretic device 32 including a plurality of microcapsules 20. The plurality of the microcapsules 20 are fixed by a binder 23.

In the display section 5, a plurality of the pixel electrodes 35 are arranged so as to overlie the piezoelectric device 32 side of the device substrate 30. The electrophoretic device 32 is adhered to the pixel electrodes 35 through an adhesive layer 33.

The device substrate 30 is made of a material such as glass or plastic. The device substrate 30 is disposed on a side on which an image is displayed and therefore has transparency. A color filter CF is formed on a surface of the device substrate 30, includes colored layers 51r, 51g, and 51b, and includes a protection layer 52. A circuit layer 34 is formed on the color filter CF and includes the scanning lines 66, the data lines 68, and the selection transistors TRa and TRb. The pixel electrodes 35 are sequentially formed on the top surface of the circuit layer 34.

Each of the pixel electrodes 35 is formed as a transparent electrode made of MgAg, ITO, or IZO (oxide of indium and zinc). Although specific illustration is omitted, the scanning lines 66, data lines 68, and selection transistors TRa and TRb each illustrated in FIGS. 3 and 4 are provided between each of the pixel electrodes 35 and the device substrate 30.

The counter substrate 31 is made of a material such as glass or plastic. The counter substrate 31 is disposed on the side opposite to the image-displaying side and need not therefore have transparency. A planar common electrode 37 is formed on the electrophoretic device 32 side of the counter substrate 31 so as to face the plurality of the pixel electrodes 35. The electrophoretic device 32 is formed on the common electrode 37. The common electrode 37 of the embodiment is a so-called reflecting electrode having light reflectivity. Examples of a material of the common electrode 37 may include a metallic material such as Cr, Mo, an Mo alloy, Al, an Al alloy, Ta, Ti, an Ag alloy, and an Ni alloy. Examples of the material of the reflecting electrode are not limited to metallic materials but may include conductive plastic materials exhibiting metallic luster. Because the common electrode 37 is formed as a reflecting electrode, the common electrode 37 is capable of reflecting light beams that are included in incident light beams from the device substrate 30 side, that are not reflected by the electrophoretic particles, and that then pass through a gap between the electrophoretic particles or between the microcapsules 20. Therefore, light use efficiency can be improved, and the brightness of the display section 5 is capable of being increased.

In general, the electrophoretic device 32 is preliminarily formed at the counter substrate 31 side and is constructed as a part of an electrophoretic sheet which includes the structures from the counter substrate 31 to the adhesive layer 33. In the manufacturing process, the electrophoretic sheet is used in a state in which a protective separation sheet is adhered to a surface of the adhesive layer 33. Then, the electrophoretic sheet from which the separation sheet has been removed is attached to the separately manufactured device substrate 30 (including the pixel electrodes 35 and various circuits), and thereby the display section 5 is produced. Accordingly, the adhesive layer 33 is provided only on the side of each of the pixel electrodes.

FIG. 4B is a cross-sectional view schematically illustrating the microcapsule 20.

The microcapsule 20 has a diameter of, for example, approximately 50 μm and has a spherical shape in which a dispersion medium 21, a plurality of white particles (electrophoretic particles) 27, and a plurality of black particles (electrophoretic particles) 26 are encapsulated. The microcapsules 20 are disposed between the common electrode 37 and each of the pixel electrodes 35 as illustrated in FIG. 4A, and one or more microcapsules 20 are placed in a single pixel 40.

Examples of a material of a shell portion (wall film) of the microcapsule 20 include an acrylic resin such as polymethylmethacrylate or polyethylmethacrylate, urea resin, and a translucent polymer resin such as gum arabic.

The dispersion medium 21 is a liquid that serves to disperse the white particles 27 and the black particles 26 inside the microcapsule 20. Examples of the dispersion medium 21 include water, alcohol solvents (such as methanol, ethanol, isopropanol, butanol, octanol, and methyl cellusolve), esters (such as ethyl acetate and butyl acetate), ketones (such as acetone, methyl ethyl ketone, and methyl isobutyl ketone), aliphatic hydrocarbons (such as pentane, hexane, and octane), alicyclic hydrocarbons (such as cyclohexane and methylcyclohexane), aromatic hydrocarbons [such as benzene, toluene, and benzene compounds having long chained alkyl group (such as xylene, hexylbenzene, hebutylbenzene, octylbenzene, nonylbenzene, decylbenzene, undecylbenzene, dodecylbenzene, tridecylbenzene, and tetradecylbenzene)], halogenated hydrocarbons (such as dichloromethane, chloroform, carbon tetrachloride, and 1,2-dichloroethane), and carboxylate. In addition, other oils may be used. These materials may be used alone or in combination and may be mixed with a surfactant or the like.

The white particles 27 are formed as particles (polymer or colloid) made of, for example, a white pigment such as titanium dioxide, Chinese white (zinc oxide), or antimony trioxide. For example, the white particles 27 are negatively charged to be used. The black particles 26 are formed as particles (polymer or colloid) made of, for example, a black pigment such as aniline black or carbon black. For example, the black particles 26 are positively charged to be used.

The following additives can be added to the pigments, where appropriate: a charge control agent made of particles of, for example, an electrolyte, a surfactant, a metallic soap, resin, rubber, oil, varnish, or a compound; a dispersant such as a titanate coupling agent, an aluminate coupling agent, or a silane coupling agent; a lubricant agent; or a stabilizer.

In addition, in place of the black particles 26 or the white particles 27, a red, green, or blue pigment can be used, for example. By virtue of this configuration, the display section 5 is capable of displaying a red, green, or blue color.

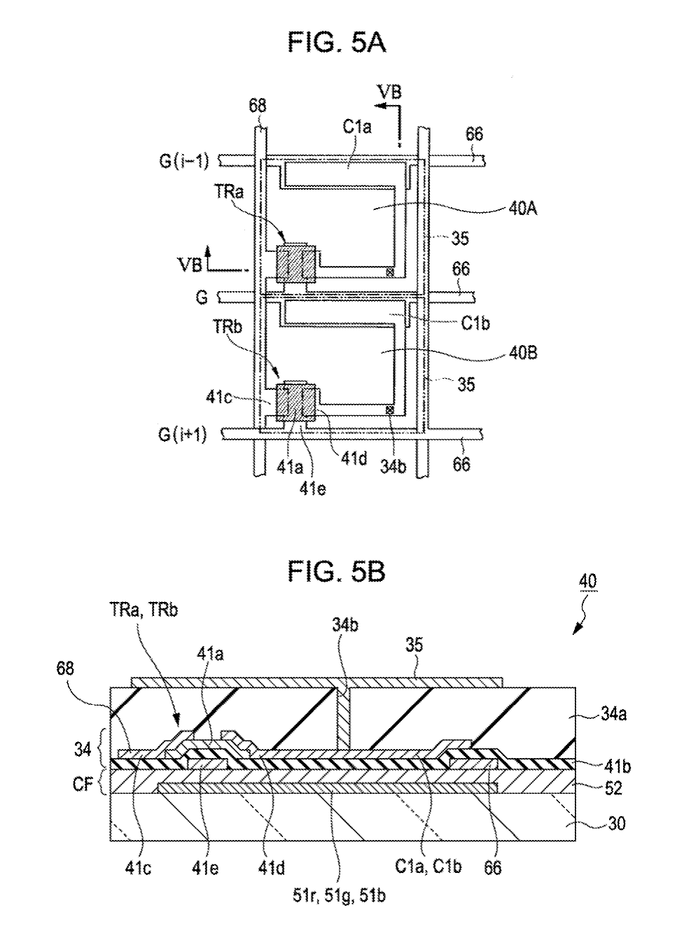

FIG. 5A is a plan view illustrating the pixels 40 formed on the device substrate 30. FIG. 5B is a cross-sectional view illustrating one of the pixels 40 taken along a line VIB-VIB in FIG. 5A.

With reference to FIG. 5A, each of the selection transistors TRa and TRb has a semiconductor layer 41a having a substantially rectangular shape in a plan view, a source electrode 41c extending from the data line 68, a drain electrode 41d that serves to connect the semiconductor layer 41a to the pixel electrode 35, and a gate electrode 41e extending from the scanning line 66. Furthermore, in the pixels 40A and 40B, the respective storage capacitors C1a and C1b are formed in regions in which the pixel electrodes 35 overlap the scanning lines 66.

In recent years, highly fine structures have been progressively imparted to small display panels. Such progress has caused crosstalk to readily arise resulting from parasitic capacitances between electrodes and between interconnections, and large storage capacitors have been therefore required. However, the progress of highly fine structures has led to a portion of the data line 68 or scanning line 66 other than the pixel electrode 35 being of increased size, and therefore a problem has significantly been caused in which a storage capacitor has been enlarged with the result that an aperture ratio of a pixel has been decreased. In the case where the size of the storage capacitor has been increased, the aperture ratio of the pixel has been decreased, and therefore sufficient image contrast has not been able to be provided. Accordingly, in this case, it has been difficult to view an image from the device substrate 30 side.

Accordingly, in the embodiment, each of the storage capacitors C1a and C1b is configured so as to have a decreased size relative to the size of the pixel electrode 35, so that the proportion of the size of each of the storage capacitors C1a and C1b is decreased relative to that of the pixel region. In addition, part of the scanning line 66 extends in a protruding manner so as to overlap the pixel electrode 35, and a Cs-on-gate structure is namely employed, so that the size of a light transmission section 42 at which a circuit device is not formed is increased. Therefore, an aperture ratio in the pixel 40 is increased, and incident light from the rear side of the device substrate 30 can be sufficiently transmitted.

With reference to a cross-sectional configuration illustrated in FIG. 5B, a gate electrode 41e (scanning line 66) made of Al or an Al alloy is formed so as to overlie the device substrate 30, and a gate insulating film 41b made of silicon oxide or silicon nitride is formed so as to cover the gate electrode 41e. The gate insulating film 41b has a thickness of approximately 300 nm. The semiconductor layer 41a made of amorphous silicon or polysilicon is formed in a region in which the semiconductor layer 41a faces the gate electrode 41e with the gate insulating film 41b interposed therebetween. The source electrode 41c and drain electrode 41d made of Al or an Al alloy are formed so as to partially cover the semiconductor layer 41a. An interlayer-insulating film 34a made of silicon oxide or silicon nitride is formed so as to cover the source electrode 41c (data line 68), the drain electrode 41d, the semiconductor layer 41a, and the gate insulating film 41b. The pixel electrode 35 is formed on the interlayer-insulating film 34a. The pixel electrode 35 is connected to the drain electrode 41d through a contact hole 34b that penetrates through the interlayer insulating film 34a to the drain electrode 41d. The selection transistors TRa and TRb are configured in this manner.

In this case, each of the gate electrode 41e, pixel electrode 35, and various interconnections has a thickness of approximately 100 nm to 300 nm. In order to decrease the electrical impact of each of the gate electrode 41e and various interconnections on the electrophoretic device 32, each of these components preferably has a narrow width. Specifically, a width of less than or equal to approximately 4 μm is preferable.

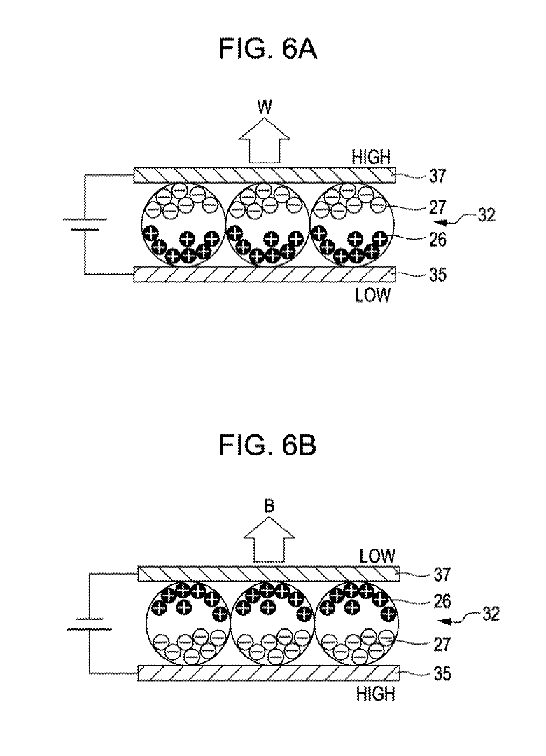

FIGS. 6A and 6B illustrate operation of the electrophoretic device 32. FIG. 6A illustrates the case in which the pixel 40 displays white color. FIG. 6B illustrates the case in which the pixel 40 displays black color.

In the case of displaying black color as illustrated in FIG. 6A, the common electrode 37 is held at a relatively high potential, and the pixel electrode 35 is held at a relatively low potential. Therefore, negatively charged white particles 27 are attracted to the common electrode 37, and, on the other hand, positively charged black particles 26 are attracted to the pixel electrode 35. Consequently, viewing the pixel from the pixel electrode 35 side that functions as a display surface, black color (B) is visibly recognized.

In the case of displaying white color as illustrated in FIG. 6B, the common electrode 37 is held at a relatively low potential, and the pixel electrode 35 is held at a relatively high potential. Therefore, positively charged black particles 26 are attracted to the common electrode 37, and, on the other hand, negatively charged white particles 27 are attracted to the pixel electrode 35. Consequently, viewing the pixel from the common electrode 37 side, black color (B) is visibly recognized.

FIGS. 6A and 6B illustrate the operation in the cases where the black particles 26 are positively charged and where the white particles 27 are negatively charged, the black particles 26 may be negatively charged, and the white particles 26 may be positively charged, where appropriate. In this case, an electric voltage is supplied similarly to in the case described above, and then the pixel performs display in a state in which white color and black color are inverted.

In the electrophoretic display device 100 having the above configuration, environmental light enters from the device substrate 30 side in the daytime or in a bright place such as a room interior, then passes through the electrophoretic device 32, is then reflected by the common electrode 37, and then passes through the electrophoretic device 32 again to be emitted. Therefore, viewing the electrophoretic display device 100 from the device substrate 30 side, reflection-type display is visibly recognized.

Although most of the incident light from the device substrate 30 side is actually reflected by the electrophoretic particles, light that has passed through a gap between the particles or between the microcapsules 20 is reflected by the common electrode 37. In this manner, the light that passes through the gap between the particles or between the microcapsules 20 is sufficiently utilized.

In the embodiment, the Cs-on-gate structure is employed to increase the aperture ratio of each of the pixels 40, and the common electrode 37 functions as a reflecting electrode, so that the transmissivity and reflectivity of light that enters the electrophoretic device 32 are improved. The common electrode 37 is formed as the reflecting electrode, so that the common electrode 37 is capable of reflecting light beams that are included in incident light beams from the device substrate 30 side, that are not reflected by the electrophoretic particles, and that then pass through the gap between the electrophoretic particles or between the microcapsules 20.

Accordingly, an amount of light emitted from the side of the device substrate 30 is increased, and therefore the brightness on the device substrate 30 side is increased with the result that visibility is enhanced, thereby an advantageous effect of improved image contrast being able to be provided. In a reflection-type display device in which an image to be displayed is viewed from the device substrate 30 side, a transistor or interconnection is prevented from functioning to decrease light transmissivity and light reflectivity, so that users are capable of visibly recognizing all of the images on the display device. Furthermore, environmental light such as natural light is efficiently utilized to improve light reflectivity, so that light used for display can be secured at low power consumption.

Furthermore, in the embodiment, the color filter CF is disposed between the device substrate 30 and the circuit layer 34, so that the color filter CF is positioned near the pixel electrode 35. Therefore, an image viewed from the device substrate 30 side does not exhibit a blur gradation boundary, and misalignment does not occur between a color boundary of the color filter CF and either of a color boundary of the electrophoretic device 32 or the outline of the image, and thereby being generation of moire or the like can be avoided. Accordingly, contrast of an image to be displayed is improved, and visibility is enhanced.

### Second Embodiment

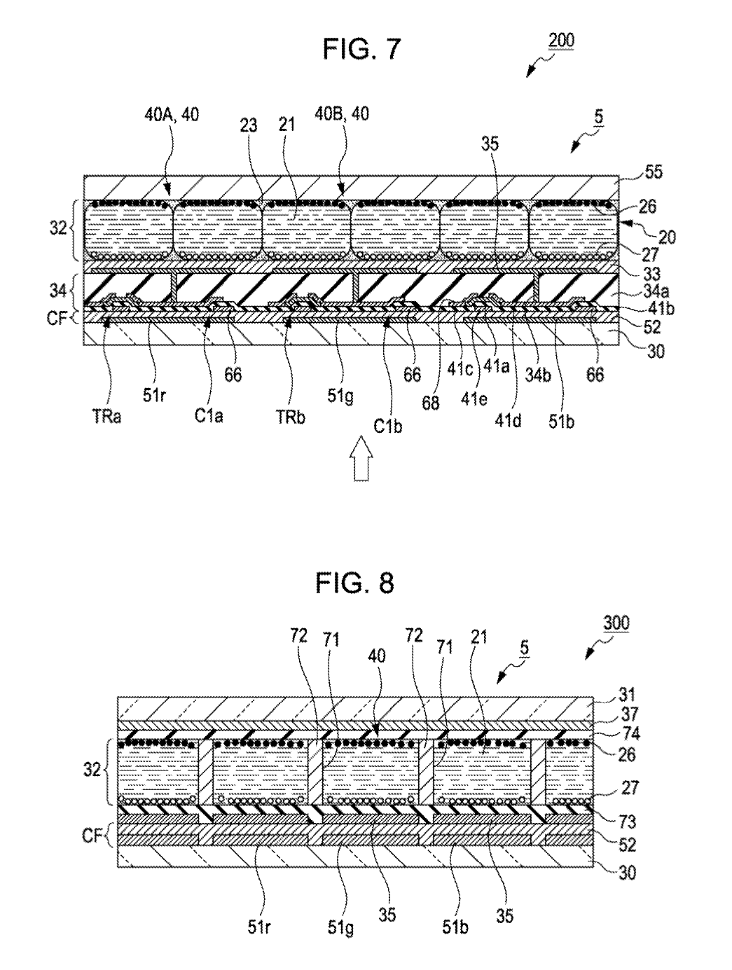

An electrophoretic display device 200 according to a second embodiment of the invention will be described. FIG. 7 is a cross-sectional view illustrating the electrophoretic display device 200 of the embodiment. The electrophoretic display device 200 of the embodiment has a difference in the configuration of a counter substrate relative to that in the first embodiment.

In the electrophoretic display device 200 of the embodiment, a metallic substrate 55 is used as a counter substrate. Examples of a material of the metallic substrate 55 include Cr, Mo, an Mo alloy, Al, an Al alloy, Ta, Ti, an Ag alloy, an Ni alloy. The metallic substrate 55 serves as the outermost layer of the electrophoretic display device 200 and therefore preferably has rigidity. A common electrode is not formed at the inside from the metallic substrate 55 before being attached to the device substrate 30, and the metallic substrate 55 is produced such that an electrophoretic sheet as the electrophoretic device 32 directly adheres thereto. Namely, the metallic substrate 55 of the embodiment also functions as the common electrode and receives a voltage supplied from the common electrode-driving circuit 6 that is connected through interconnections (not illustrated).

The appropriate common electrode-voltage potential Vcom is supplied from the common electrode-driving circuit 6, so that a potential difference is generated between the metallic substrate 55 and the pixel electrode 35 with the result that the electrophoretic device 32 is driven owing to the potential difference to display an image on the display section 5.

In the electrophoretic display device 200 of the embodiment, the metallic substrate 55 is employed as the counter substrate and is therefore capable of functioning as the common electrode. Accordingly, manufacturing processes of the common electrode can be decreased, leading to simple manufacturing processes. Furthermore, the metallic substrate 55 is employed, and therefore the substrate itself has light reflectivity, so that the metallic substrate 55 is capable of reflecting light beams toward the device substrate 30 side, the light beams being included in incident light beams from the side of the device substrate 30, passing through the gap between the particles 26 and 27 or between the microcapsules 20, and then reaching the metallic substrate 55. Accordingly, light utilization efficiency is improved. Consequently, the brightness on the device substrate 30 side is improved with the result that visibility is enhanced, and image contrast is improved, and namely the advantageous effects the same as above are capable of being provided.

### Third Embodiment

An electrophoretic display device 300 according to a third embodiment of the invention will be described. FIG. 8 is a cross-sectional view illustrating the electrophoretic display device 300 of the embodiment in an enlarged manner. The electrophoretic display device 300 of the embodiment has a difference in the configuration of a counter substrate relative to that of each of the foregoing embodiments. In FIG. 8, illustration of the selection transistors TRa and TRb is omitted.

The electrophoretic display device 300 of the embodiment has the counter substrate 31 on which the common electrode 37 and an insulating layer 74 are formed in sequence and has the device substrate 30 that is disposed so as to face the counter substrate 31 with the electrophoretic device 32 interposed between the device substrate 30 and the counter substrate 31. Partitions 72 are provided between the counter substrate 31 and the device substrate 30 to divide the electrophoretic device 32 into a plurality of sections.

Each of the partitions 72 is formed in a grid manner in a plan view so as to have a certain height in a thickness direction of the electrophoretic display device 300, thereby defining (sectioning) a plurality of enclosed spaces. A material having light reflectivity is used to form each of the partitions 72. An example of the material of the partition 72 includes a conductive plastic material exhibiting metallic luster. Each of the partitions 72 is electrically separated from the common electrode 37 through the insulating layer 74, and therefore the metallic material described above as the material of the reflecting electrode may be used to form each of the partitions 72. As in the case of the first embodiment, the common electrode 37 of this embodiment is also formed as an electrode having light reflectivity.

The insulating layer 74 covers a surface of the common electrode 37, and therefore the common electrode 37 can be protected from an influence of the dispersion medium 21, thereby being able to prevent electrode deterioration.

By virtue of these configurations, a space inside a frame-like structure formed by the partitions 72 is segmented into a plurality of the enclosed spaces 71 in a matrix manner. The enclosed spaces 71 are individually sealed in an airtight manner between the counter substrate 31 and the device substrate 30. The insulating layer 73 is formed so as to overlie the top surface of the device substrate 30 and so as to cover the plurality of the pixel electrodes 35, the top surface being positioned at the inside from the device substrate 30 (positioned at the side opposite to the counter substrate 31). Accordingly, even in the case where each of the partitions 72 has electrical conductivity, insulation properties are secured between the pixel electrodes 35 and the partitions 72, and the electrodes can be protected from an influence of the dispersion medium 21. The dispersion medium 21, white particles 27, and the black particles 26, which form the electrophoretic device 32, are encapsulated in the individual enclosed spaces 71 defined by the partitions 72. The black particles 26 and white particles 27 individually move inside the enclosed spaces 71.

According to the configuration of the embodiment, the partitions 72 each having light reflectivity are provided, so that incident light from the device substrate 30 side is reflected by each of the partitions 72 as well as the common electrode 37. Therefore the brightness of each of the pixels 40 is improved, and better visibility can be provided.

Although the preferred embodiments of the invention have been described with reference to the accompanying drawings, embodiments of the invention are not obviously limited to the embodiments described above. Those skilled in the art well know that the above embodiments of the invention can be appropriately changed and modified within the scope and spirit of the invention. Such changes and modifications obviously fall within the scope of the invention.

For example, the shell portion (wall film) of each of the microcapsules 20 included in the electrophoretic device 32 may have light reflectivity. In this case, for example, a configuration is suggested, in which a reflective film is formed on a semispherical surface of each of the microcapsules 20 and in which each of the microcapsule 20 is arranged such that the reflective film faces the counter substrate 31. Accordingly, incident light from the device substrate 30 side enters the transparent side of the wall film of each of the microcapsules 20, is then reflected by the reflective film, and is then emitted to the outside. In the case where the reflective film sufficiently produces reflected light, a typical common electrode and counter substrate may be used without being provided with light reflectivity, or the reflective film may be used in combination with the common electrode 37 having light reflectivity (see, FIG. 4) or in combination with the counter substrate (metallic substrate 55, see, FIG. 7).

The binder 23 that fixes the microcapsules 20 may have light reflectivity. Accordingly, light that does not enter the common electrode 37 is capable of being reflected. Namely, light beams that pass through the microcapsules 20 are reflected by the common electrode 37, and the other light beams are reflected by the binder 23.

By virtue of such configurations, environmental light can be sufficiently utilized, and the brightness of the display section 5 is improved, thereby providing better visibility.

Although an example in which the amorphous silicon TFTs are used as the selection transistors TRa and TRb has been described in the above embodiments, channel etch-type amorphous silicon TFTs, high temperature poly-silicon (HIPS) TFTs, low temperature poly-silicon (LTPS) TFTs, oxide TFTs, or organic TFTs may be used.

### Electronic Apparatus

Examples will be described, in which the electrophoretic display devices 100, 200, and 300 of the above embodiments are applied to electronic apparatuses.

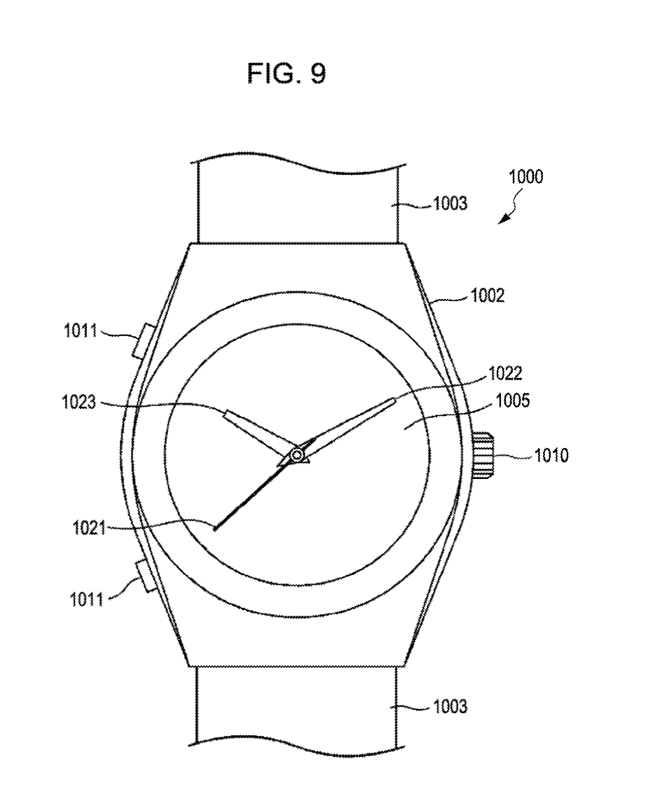

FIG. 9 is an elevational view illustrating a watch 1000. The watch 1000 includes a watch case 1002 and a pair of bands 1003 connected to the watch case 1002.

The watch case 1002 has a display 1005 including the electrophoretic display device according to any of the above embodiments, a second hand 1021, a minute hand 1022, and an hour hand 1023, each being provided on a front side of the case 1002. A winder 1010 as a control is provided on one side of the case 1002, and an operation button 1011 is provided on another side of the watch case 1002. The winder 1010 is connected to a setting stem (not illustrated) provided inside the case 1002 and is provided so as to be able to be pushed and pulled in multiple stages (for example, two stages) and so as to be able to be rotated while being integrated with the setting stem. The display 1005 is capable of displaying an image as a back ground, a character string such as data or time, a second hand, a minute hand, or an hour hand thereon.

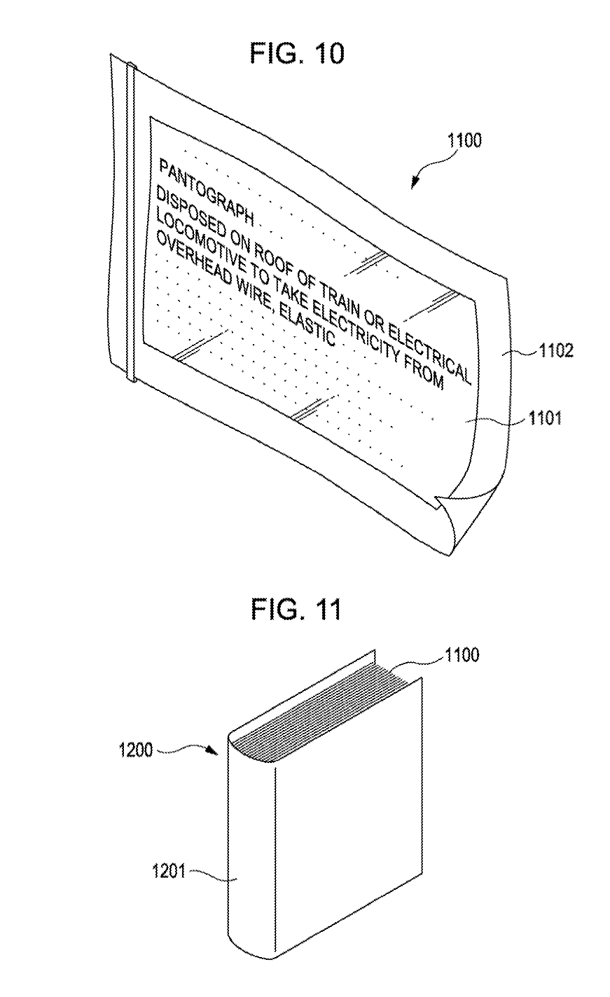

FIG. 10 is a perspective view illustrating the configuration of electronic paper 1100. The electronic paper 1100 includes the electrophoretic display device according to any of the above embodiments in a display region 1101. The electronic paper 1100 has flexibility and includes a body 1102 formed by using a rewritable sheet having texture and flexibility the same as those of ordinary paper.

FIG. 11 is a perspective view illustrating the configuration of an electronic notebook 1200. In the electronic notebook 1200, a plurality of the electronic paper 1100 are stacked and covered with a cover 1201. For example, the cover 1201 has a display data input unit (not illustrated) with which display data transmitted from an external device is input. Accordingly, display contents can be changed in response to such display data while the electronic paper is left in a stacked state.

Because each of the electrophoretic display devices according to the embodiments of the invention is applied to the watch 1000, the electronic paper 1100, and the electronic notebook 1200, there is provided an electronic apparatus including a display section having excellent operation reliability and high display quality.

Each of the above electronic apparatuses is an example according to embodiments of the invention and does not limit the scope of the invention. For example, the electrophoretic display devices according to embodiments of the invention also can be preferably applied to display sections of electronic apparatuses such as a mobile phone and a portable audio visual apparatus.

What is claimed is:

1. An electrophoretic display device comprising:
a first substrate;
a second substrate that is disposed so as to face the first substrate;
an electrophoretic device that is disposed between the first substrate and the second substrate;
a plurality of first electrodes that are formed so as to overlie the electrophoretic device side of the first substrate; and
a second electrode that is formed on the electrophoretic device side of the second substrate so as to face the plurality of the first electrodes, wherein
the second electrode has light reflectivity.

2. The electrophoretic display device according to claim 1, wherein a color filter is formed between the first substrate and the electrophoretic device.

3. The electrophoretic display device according to claim 1, wherein the second substrate has electrical conductivity and functions as the second electrode.

4. The electrophoretic display device according to claim 1, further comprising:
a plurality of scanning lines that are individually connected to at least one of the plurality of the first electrodes through a selection transistor; and
a storage capacitor connected to a corresponding one of the plurality of the first electrodes and having a pair of electrodes, wherein
a corresponding one of the scanning lines functions as one of the pair of the electrodes.

5. The electrophoretic display device according to claim 1, wherein
the electrophoretic device has a plurality of microcapsules in which a plurality of electrophoretic particles are encapsulated, wherein
the plurality of the microcapsules are fixed by a binder between the first substrate and the second substrate, the binder having light reflectivity.

6. The electrophoretic display device according to claim 1, wherein
a partition having light reflectivity is formed between the first substrate and the second substrate, and
the partition, electrophoretic particles, and a dispersion medium form the electrophoretic device, the electrophoretic particles and dispersion medium being enclosed in a space defined by the partition.

7. An electronic apparatus comprising the electrophoretic display device according to claim 1.

8. An electronic apparatus comprising the electrophoretic display device according to claim 2.

9. An electronic apparatus comprising the electrophoretic display device according to claim 3.

10. An electronic apparatus comprising the electrophoretic display device according to claim 4.

11. An electronic apparatus comprising the electrophoretic display device according to claim 5.

12. An electronic apparatus comprising the electrophoretic display device according to claim 6.
